(19) United States
(12) Patent Application Publication
(10) Pub. No.: US 2026/0153988 A1
(43) Pub. Date: Jun. 4, 2026

(54) ADJUSTED RATE CONTROL IN A MEMORY SUB-SYSTEM

(71) Applicant: Micron Technology, Inc., Boise, ID (US)

(72) Inventors: Ying Huang, Boise, ID (US); Beichen Liu, Boise, ID (US)

(21) Appl. No.: 18/966,947

(22) Filed: Dec. 3, 2024

(51) Int. Cl. G06F 3/06

(52) U.S. Cl. CPC G06F 3/061; G06F 3/0659; G06F 3/0673

(57) ABSTRACT

A processing device in a memory system identifies a set of victim blockstripes associated with a media management operation to be executed relating to the memory device. The processing device determines a set of initial valid data rates corresponding to the set of victim blockstripes. The processing device generates a set of adjusted valid data rates based at least in part on the set of initial valid data rates. The processing device executes the media management operation based at least in part on the set of adjusted valid data rates.

### TECHNICAL FIELD

Embodiments of the disclosure relate generally to memory sub-systems, and more specifically, relate to implementing automatic rate control in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is an example graph of a host rate and garbage collection rate over time during a first state memory condition and a second state memory condition of a memory device in accordance with some embodiments of the present disclosure.

FIG. 3 is a flow diagram of an example method to implement automatic rate control for a memory device in accordance with some embodiments of the present disclosure.

FIG. 4 is a flow diagram of an example method to implement automatic rate control for a memory device in accordance with some embodiments of the present disclosure.

FIG. 5 is a block diagram of an example computer system in which embodiments of the present disclosure may operate.

### DETAILED DESCRIPTION

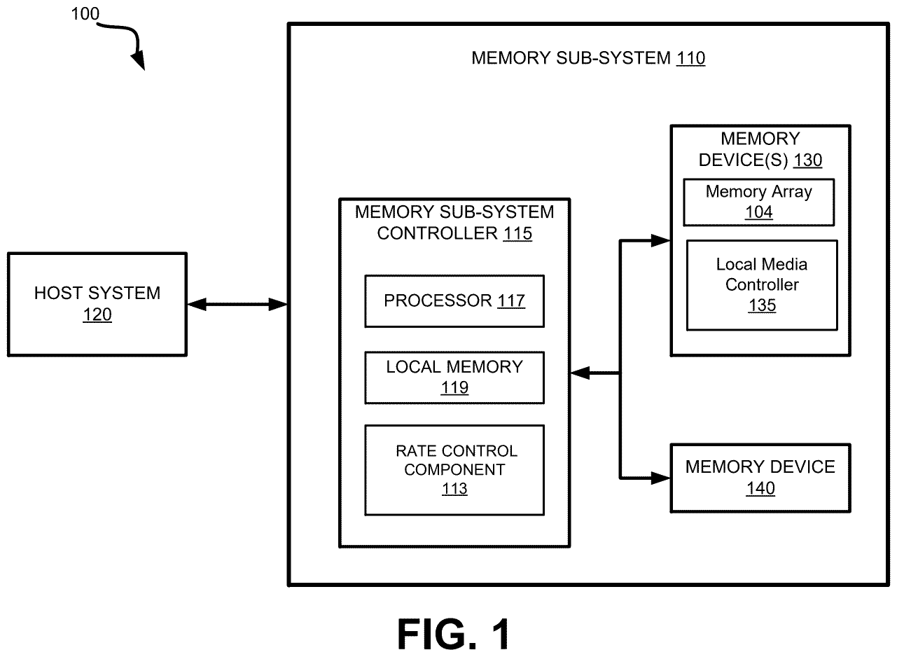

Aspects of the present disclosure are directed to implementing automatic rate control in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

When data is written to the memory sub-system, it is typically done at the page level, such that an entire page, or multiple pages, is written in a single operation. In a conventional memory sub-system, a host system can provide data to be written to the memory sub-system. When the memory sub-system is full, such that there is insufficient capacity to accept additional write operations from the host system, certain data can be erased in order to free up space. When data is erased from the memory sub-system, however, it is typically done at the block level, such that an entire block (including multiple pages) is erased in a single operation. Thus, when a particular segment of data on the memory sub-system is updated, for example, certain pages in a block will have data that has been rewritten to a different page and/or is no longer needed. The entire block cannot simply be erased as each block likely also has some number of pages of valid data.

One or more media management operations can be performed to optimize the storage functionality of a memory device. For example, a media management operation such as data folding (also referred to herein as “garbage collection”) can be executed to move valid data from one memory portion of a memory device to another memory portion of the memory device. In some examples, a data folding operation or garbage collection operation can be used for increasing an amount available space in the memory device. Garbage collection is a process of reclaiming unused or invalid data blocks to free up space and optimize memory utilization. A garbage collection process can include identifying valid data in one or more blockstripes (e.g., one or more blocks that are typically programmed and erased together), moving the valid data to one or more other blockstripes, and erasing the blockstripes that no longer contain any valid data. By consolidating free space and reducing fragmentation, garbage collection can help maintain efficient storage performance. In some other examples, the data folding operation may be associated with a static wear leveling operation. Static wear leveling is a technique used in memory devices to distribute write and erase cycles evenly across all memory cells of the memory device. Wear leveling algorithms can be used to periodically move data from frequently used cells to less frequently used cells, or to direct new write operations towards the less frequently used cells, thereby improving a likelihood of balanced usage of all available memory cells. This even distribution of wear can improve the reliability and performance of the memory device as each cell has a limited number of program/erase cycles (PEC). Additionally, the even distribution of wear can prevent certain cells from wearing out prematurely due to frequent use, thereby extending the overall lifespan of the memory device.

Garbage collection can be performed on a blockstripe, e.g., a collection of blocks that are treated as a unit. The blockstripe can be a single block or one or more blocks. Moving data from one blockstripe (i.e., a “victim” blockstripe or “folding victim blockstripe” representing the blockstripe where data is being retrieved to be written elsewhere) to another blockstripe during the garbage collection process results in additional writes (also referred to as “folding writes”) to the memory sub-system. The amount of valid data that is to be moved from one blockstripe to another blockstripe is known as a valid data rate or physical valid translation-unit count (PVTC) rate. The valid data rate (or PVTC rate) represents a ratio of a valid translation-unit (TU) count in a blockstripe to a total TU count in the blockstripe. In operation, the lower the PVTC rate, the slower the garbage collection process needs to run.

In a conventional memory sub-system, the performance seen by the host system is dependent on the speed at which the media management operation (e.g., a folding or garbage collection process) runs. If the host system issues write commands at a rate faster than the rate that the garbage collection process can support, the memory sub-system may not have enough free space remaining for the host system to write to and would thus need to wait until the garbage collection process frees up space. In conventional systems, the garbage collection rate needed to support a given host rate depends on the PVTC rate, where a higher PVTC rate requires the garbage collection process to run much faster than the host write processing to keep the free space in balance. In many cases, an uneven balance between the host system and the garbage collection process can result in unstable performance if there are fluctuating workload condition changes that affect how fast the host system and the garbage collection process are each running. Host systems utilizing conventional memory sub-systems are designed to perform according to a customer's expectations under stable or changing workload conditions. However, since the performance seen by the host system depends on the speed of the garbage collection process, it may fail to meet the customer's expectations under stable or changing workload conditions.

Some conventional systems include a rate control system to adaptively control the rate at which memory sub-system processes host system writes (i.e., a host write rate) and a rate at which folding-related write operations are performed (i.e., a folding rate). The rate control system performs operations to prevent the memory drive from running out of available or free space needed to serve host write requests (i.e., maintain free space to satisfy the host write rate), to maintain target performance and quality of service metrics under various workload conditions.

The rate control system can include a rate calculator that calculates the host write rate and the folding write rate. In some implementations, the rate calculator calculates the “optimal” or “best” rates based on one or more conditions or factors, such as current input/output data statistics, the drive conditions, an amount of valid data on the current folding victims, etc. The output of the rate calculator is a set of rates that can be used by one or more modules (also referred to as “credit regulators”) that control one or more write data paths associated with the memory sub-system. The credit regulators may use the PVTC rate to replenish the “credit” or amount of work that a write path (e.g., a host write path or a folding write path) can consume. For example, a write path may be used to execute a write operation when the credit balance associated with that write path is positive.

The rate calculator may be notified when a new folding victim block is selected and use the PVTC rate and a total available space on the victim blockstripe if the blockstripe is folded. Accordingly, when calculating the write host rate and folding write rate, the rate calculator accesses data that reflects the amount of valid data on a current folding victim based on a current workload. However, dependence on only the current folding victim and current workload can result in an imbalance between optimizing host write performance and maintaining a sufficient level of free space in the memory sub-system. For example, calculating the write rates based only on the current workload can lead to a temporarily high PVTC folding victim which produces large variations in drive performance. In such instances, the temporarily high PVTC folding victim causes the rate calculator to automatically throttle the host write rate in view of the calculated folding write rate resulting in a slowed generation of free space.

Aspects of the present disclosure address the above and other deficiencies by having a memory sub-system that determines an adjusted or “virtual” valid data rate or physical valid translation-unit count rate (PVTC rate) for use in calculating one or more rates (e.g., a host write rate and a folding write rate) associated with execution of a media management operation (e.g., a folding operation). According to embodiments, the adjusted valid data rate is determined for use in calculating one or more write rates (i.e., a host write rate and/or a folding write rate). In an embodiment, control logic determines the adjusted valid data rate to enable the rate calculator to generate write rates applicable for a current victim blockstripe (also referred to as a “current folding victim blockstripe”) which includes a memory blockstripe that is targeted to have stored data retrieved to be written elsewhere). According to embodiments, the adjusted valid data rate is determined based at least in part on a potential upcoming workload (i.e., a workload associated with one or more future or upcoming folding victims (herein one or more “upcoming folding victim(s)”).

According to embodiments, control logic calculates the adjusted valid data rate by iterating through a set of folding victim blockstripe candidates. In embodiments, for each folding victim blockstripe of the set of folding victim blockstripe candidates, an initial valid data rate (i.e., an initial PVTC rate is determined). In an embodiment, the initial valid data rate (PVTC rate) is determined as a ratio of a valid translation-unit (TU) count in a blockstripe to a total TU count in the blockstripe. In embodiments, the control logic identifies a sequence of the set of folding victim blockstripes to be used in one or more folding operations (i.e., a chronological order in which the folding victim blockstripes will be worked on during the one or more folding operations). In an embodiment, the control logic can then estimate (e.g., interpolate) the initial valid data rate of the set of folding victim blockstripe candidates to generate the adjusted valid data rate. According to embodiments, the control logic constructs an approximation (i.e., a curve) representing the adjusted valid data rate (i.e., the adjusted PVTC rate curve) by interpolating an initial valid data rate associated with a current folding victim blockstripe and initial valid data rates associated with the set of folding victim blockstripe candidates.

Some advantages of the present disclosure include enabling a processing device to perform data folding based on the adjusted valid data rate of a data folding queue. Advantageously, the adjusted valid data rate accounts for changes in the potential or future workload associated with the set of folding victim blockstripe candidates. The adjusted valid data rate can then be used in transitioning from one folding victim blockstripe to another during a folding operation. Advantageously, establishing the adjusted valid data rate in view of the anticipated workload associated with the upcoming folding victim improves efficiency in instance when there are significant valid data rate variations (i.e., PVTC rate variations) among folding victim blockstripes. Furthermore, generating and using the adjusted valid data rate avoids instances when a folding victim having a temporarily high PVTC rate causes the control logic to automatically throttle the host write rate in response to the folding write rate being too slow at generating free space to service host write requests. These example advantages, among others, are described in more detail herein.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a rate control component 113 that can implement processes to generate adjusted valid data rates (i.e., adjusted PVTC rates) associated with executing one or more media management operations (e.g., folding operations) associated with the memory sub-system 110. In some embodiments, the memory sub-system controller 115 includes at least a portion of the rate control component 113. In some embodiments, the rate control component 113 is part of the host system 120, an application, or an operating system. In other embodiments, local media controller 135 includes at least a portion of rate control component 113 and is configured to perform the functionality described herein.

The rate control component 113 can implement adjusted valid data rate control for the memory sub-system 110. In an embodiment, the rate control component 113 identifies a set of pending victim blockstripes (e.g., pending folding victim blockstripes) that may be selected for use in one or more subsequent media management operations (e.g., folding operations) (herein the “set of folding victim blockstripe candidates”). In an embodiment, the rate control component 113 determines an initial valid data rate (i.e., an initial PVTC rate) for each folding victim blockstripe of the set of folding victim blockstripe candidates. In an embodiment, the rate control component 113 generates a sequence or ordering of the set of folding victim blockstripes based on the initial valid data rate associated with each folding victim blockstripe. In an embodiment, the sequence represents a chronological order in which the pending folding victim blockstripe candidates are to be selected for use in subsequent folding operations following execution of a folding operation with respect to a current folding victim blockstripe, where the sequence represents a ranking from a lowest initial valid data rate to a highest initial valid data rate. For example, a first folding victim blockstripe candidate having a lowest initial valid rate may be placed first in the sequence of the set of folding victim blockstripe candidates, a second folding victim blockstripe candidate having a second lowest initial valid rate may be placed second in the sequence of the set of folding victim blockstripe candidates, a third folding victim blockstripe candidate having a third lowest initial valid rate may be placed third in the sequence of the set of folding victim blockstripe candidates, and so on.

According to embodiments, the rate control component 113 generates the adjusted valid data rate corresponding to each blockstripe by constructing an estimation or approximation (e.g., a least squares regression approximation) based on the initial valid data rates for the current folding victim blockstripe (e.g., the blockstripe that is subject to a current folding operation) and the ordered sequence of the set of folding victim blockstripe candidates. In an embodiment, the rate control component 113 segments or divides each blockstripe (i.e., the current folding victim blockstripe and the set of folding victim blockstripe candidates) into multiple sections (herein “blockstripe sections”), where each blockstripe section is represented by a blockstripe index value (e.g., a blockstripe index value of 0, 0.25, 0.50, 0.75, 1.00, 1.25, etc.). In an embodiment, based on the approximation representing the adjusted valid data rate, the rate control component 113 assigns each blockstripe section a corresponding adjusted valid data rate value based on the generated approximation.

According to embodiments, the rate control component 113 provides the adjusted valid data rate for the current folding victim blockstripe and set of folding victim blockstripe candidates for use in generating a host write rate (e.g., a target or desired host write rate) associated with the memory device 130. According to embodiments, the rate control component 113 can re-calculate the adjusted valid data rates in response to a change to the folding victim blockstripe candidates. For example, the rate control component 113 calculates updated adjusted valid data rates in response to a new folding victim blockstripe candidate being identified due to an immediate folding operation, due to wear-leveling, or due to workload changes. Further details with regard to the operations of the rate control component 113 are described below.

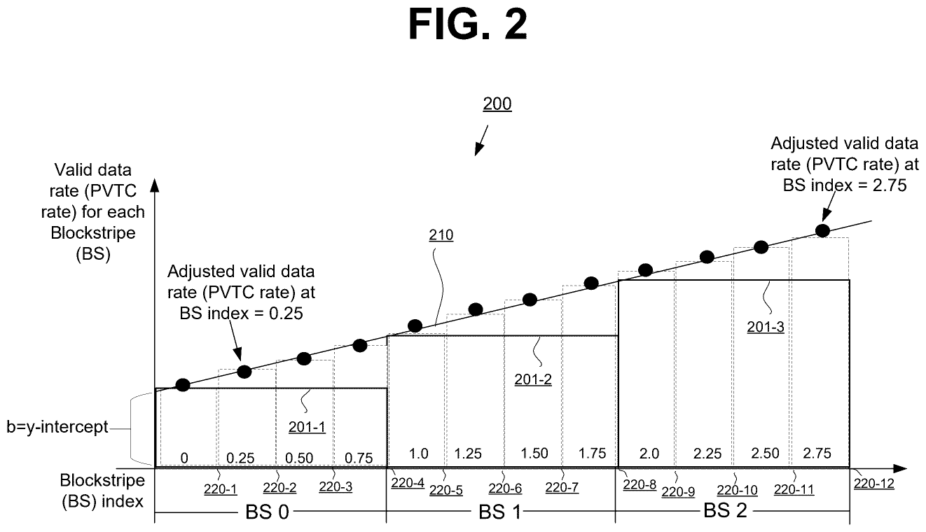

FIG. 2 is an example graph 200 representing valid data rates (e.g., initial valid data rates and adjusted valid data rates) associated with a set of folding victim blockstripes of a memory device, according to embodiments. According to embodiments, control logic (e.g., rate control component 113) determines the valid data rates associated with the set of folding victim blockstripes (e.g., blockstripe (BS) 0, BS 1, and BS2 in the example shown in FIG. 2). In the example shown in FIG. 2, BS 0 represents the current folding victim (e.g., the folding victim blockstripe subject to a current or active folding operation). In this example, BS 1 and BS 2 represent the set of folding victim candidates (e.g., a set of folding victim blockstripe candidates that may be selected for use in one or more subsequent folding operations).

In an embodiment, the graph 200 includes an X-axis representing a blockstripe (BS) index value corresponding to the folding victim blockstripes (e.g., BS 0, BS 1, and BS 2). The graph 200 further includes a Y-axis representing valid data rates (e.g., initial valid data rates and adjusted valid data rates) corresponding to the folding victim blockstripes. In an embodiment, the control logic (e.g., the rate control component 113 of FIG. 1) determines the initial valid data rate (PVTC rate) 201 for each folding victim blockstripe. The initial valid data rate may indicate a total quantity of physical valid translation units (TU) of the corresponding blockstripe. According to embodiments, the folding victim blockstripes are sequenced or arranged (from left to right) based on an initial valid data rate (PVTC rate) corresponding to each folding victim blockstripe.

As shown in this example, BS 0 is associated with a first initial valid data rate 201-1, BS 1 is associated with a second initial valid data rate 201-2, and BS 2 is associated with a third initial valid data rate 201-3, where the first initial data rate 201-1 is the smallest relative value and the third initial data rate 201-3 is the highest relative value (e.g., the folding victim blockstripes are sequenced along the X-axis in increasing order of their corresponding initial data rate 201).

As shown in the example of FIG. 2, each blockstripe is divided or segmented into a number of sections (e.g., four sections), where each section corresponding to a blockstripe index value. For example, BS 0 includes a first section corresponding to BS index value 0, a second section corresponding to BS index value 0.25, a third section corresponding to BS index value 0.50, and a fourth section corresponding to BS index value 0.75). In this example, BS 1 includes a first section corresponding to BS index value 1.0, a second section corresponding to BS index value 1.25, a third section corresponding to BS index value 1.50, and a fourth section corresponding to BS index value 1.75). In this example, BS 1 includes a first section corresponding to BS index value 2.0, a second section corresponding to BS index value 2.25, a third section corresponding to BS index value 2.50, and a fourth section corresponding to BS index value 2.75).

According to embodiments, the control logic generates an approximation 210 representing a set of adjusted valid data rates corresponding to the folding victim blockstripes. In an embodiment, the approximation 210 is based in part on the initial valid data rates associated with the blockstripes. According to embodiments, any suitable approximation method may be employed. In the example shown in FIG. 2, the approximation 210 is generated based on a least squares regression approximation method, represented by the following expression:

$$y = b + mx$$

where “y” represents an adjusted valid data rate for each folding victim blockstripe; “x” represents the blockstripe index value; “b” represents the y-intercept value or the initial valid data rate (initial PVTC rate); “m” represents a slope of the approximation line; and “N” represents a number of blockstripes used for calculating the parameters for the approximation line (i.e., the adjusted valid data rate or adjusted PVTC rate). In this example, “m” and “b” may be calculated according to the following equations:

$$m = \frac{N \sum ( xy ) - \sum x \sum y}{N \sum ( {x}^{2} ) - {( \sum x )}^{2}}$$

$$b = \frac{\sum y - m \sum x}{N}$$

According to embodiments, each section of the folding victim blockstripes (e.g., each section of BS 0, each section of BS 1, and each section of BS 2) is assigned an adjusted valid data rate (i.e., an adjusted PVTC rate) based on the approximation 210. As shown in the example of FIG. 2, an adjusted valid data rate (represented by the dots) corresponding to each blockstripe section is assigned.

According to embodiments, the control logic re-calculates or updates the adjusted valid data rates at one or more boundaries (e.g., boundaries 220-1, 220-2, 220-3 . . . 220-12 shown in FIG. 2) of the blockstripe sections. According to embodiments, the blockstripe section boundaries (e.g., boundaries 220-1 through 220-12) are established in response to changes or updates to the folding victim blockstripe candidates. For example, the control logic calculates updated adjusted valid data rates in response to a new folding victim blockstripe candidate being identified due to changes such as an immediate folding operation, wear-leveling, workload changes, etc.

According to embodiments, the adjusted valid data rate may be used to determine a host write rate. According to embodiments, the host write rate may be determined by setting a folding write rate based on a current host usage level (“hostUsage”) (e.g., a workload level) and a write allowance (“writeAllowance”) (e.g., a maximum write performance or maximum level of write operations as a function of time) in accordance with the following expression:

$$foldingRate = ( ( writeAllowance - ( readUsage / write\_read \_allowance \_ratio ) - hostUsage ) ) * F ;$$

where the “write_read_allowance_ratio” represents an estimated scale factor that reflects the impact of the host reads on the write bandwidth; where the “readUsage” represents an actual host read count recorded; where the “hostUsage” represents an actual host write count recorded; and where F is factor used to take into account a performance impact due to execution of a folding read operation during a folding operation (in an example, F can be approximately 0.8).

According to an embodiment, a ratio (“ratio”) is calculated to represent a required operation speed multiple of a folding write level over a host write level, in accordance with the following expression:

$$ratio = pvtcRatel / ( 1 - pvtcRate )$$

where the “pvtcRate” represents the valid data rate or PVTC count for a current folding victim blockstripe calculated as a percentage, and where the “ratio” represents a multiple at which the folding write rate is to be set over the host write rate, if the free space of the memory device is to be maintained at a constant level. For example, with a 50% pvtcRate folding victim blockstripe, the ratio may be set to 1.0 to keep the folding write rate and the host write rate executing at the same speed to have no net gain or loss of fee space of the memory device. In another example, for a 90% PVTC rate folding victim blockstripe, the ratio is determined to be 9.0, which means the folding write rate is be executed 9 times as fast as the host write rate does to keep the free space balance unchanged.

According to embodiments, as described above, the adjusted valid data rate (or adjusted PVTC rate (“adjusted_PvtcRate”) may be updated at blockstripe section boundaries (as shown in FIG. 2).

In an embodiment, a reference host rate (“refRate”) may be determined based at least in part on the ratio, in accordance with the following expression:

$$refRate = scanUsage / ( 1 + ratio )$$

where “scanUsage” represents a number of translation units (Tus) that have been replayed (or scanned) during a sampling period; and where the refRate is a reference write rate determined by the progress of the folding replay as measured y the scanUsage, and the ratio, which reflects the PVTC rate. In an embodiment, for a given scanUsage, the higher a PVTC rate, the higher the ratio, and the lower the refRate. In an embodiment, the refRate does not take into consideration a current free space condition.

In an embodiment, a host write rate is calculated as a scaled up or scaled down version of the refRate, based on at least in part on a current free space level. In an embodiment, if the current free space level (“freeSpace”) is above a targeted free space threshold (“targetedFreeSpace”), then:

$$lowRate = refRate$$

$$highRate = hostWriteAllowance$$

$$scaleFactor = ( freeSpace - targetedFreeSpace ) / ( max FreeSpace - targetedFreeSpace )$$

where the lowRate and highrate represent minimum and maximum values that a final hostRate can be set to after taking a current free space level into consideration to maintain a final hostRate within a desired or target range.

In an embodiment, if the current free space level (“freeSpace”) is less than the targeted free space threshold (“targetedFreeSpace”), then:

$$lowRate = hostRateGuaranteed$$

$$highRate = refRate$$

$$scaleFactor = ( targetedFreeSpace - freeSpace ) / ( freeSpace )$$

where the “hostRateGuaranteed” represents a minimum host write rate allowed.

According to embodiments, the host write rate (“hostRate”) is determined in accordance with the following expression:

$$hostRate = refRate + ( max Rate - refRate ) * scaleFactor$$

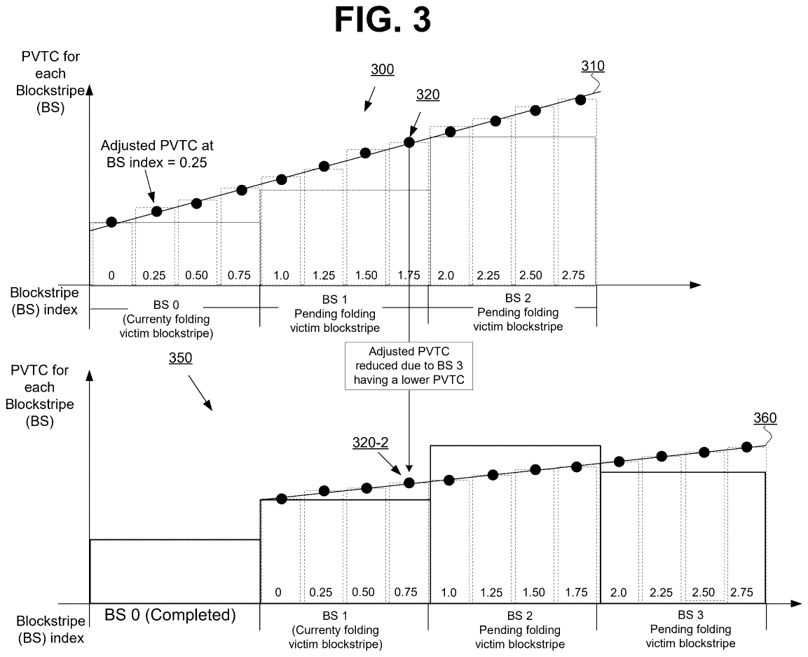

FIG. 3 illustrates example graph 300 and 350 representing an updated or re-calculated adjusted valid data rates associated with sets of folding victim blockstripes of a memory device, according to embodiments. As shown in FIG. 3, graph 300 represent data corresponding to a first time and graph 350 represents data corresponding to a second time. As shown in graph 300, at the first time, blockstripe 0 (BS 0) represents the current folding victim blockstripe and blockstripe 1 (BS 1) and blockstripe 2 (BS 2) represent a set of pending folding victim blockstripes. As shown in FIG. 3, the blockstripes in graph 300 are divided into sections and a first approximation 310 is generated to identify a first set of adjusted valid data rates (adjusted PVTC rates) that are assigned to each section of the blockstripes. At the first time, the first set of adjusted valid data rates corresponding to the first approximation 310 may be used to generate a host write rate associated with the memory device.

In FIG. 3, as shown in graph 350, at a second time, the current folding victim blockstripe is switched to BS 1 and BS 3 is added to the set of pending folding victim blockstripes (e.g., blockstripes to be folded in one or more subsequent folding operations). As shown in FIG. 3, control logic updates or re-calculates a second approximation 360 to identify a set of updated or re-calculated valid data rates (updated adjusted PVTC rates) assigned to each section of the blockstripes (e.g., BS 1 (current folding victim), BS 2 (a first pending folding victim), and BS 3 (a second pending folding victim).

According to embodiments, the control logic updates or re-calculates the adjusted valid data rate (the adjusted PVTC rate) for BS 1 (i.e., the current folding victim blockstripe) at the second time. In the example shown, the updated adjusted valid date rate 320-2 corresponding to a fourth section of BS 1 (e.g., BS index value 0.75 of graph 350) as determined at the second time is lower than the adjusted valid data rate 320-1 corresponding the same section of BS 1 (e.g., BS index value 1.75 of graph 300) due to BS 3 having a lower valid data rate (PVTC rate) as compared to the valid data rate (PVTC rate) of BS 2. According to embodiments, in this example, the updated adjusted valid data rate for BS 1 determined at the second time is lowered (as compared to the adjusted valid data rate for BS 1 determined at the first time) to account for the expected decrease in the folding workload corresponding to the pending folding victim blockstripes (e.g., BS 2 and BS 3).

According to embodiments, the updated adjusted valid data rate (updated adjusted PVTC rate) can be re-calculated at the second time (i.e., the updated approximation 360) in response to identifying a change associated with the pending folding victim blockstripes. In this example, the updated approximation 360 is generated in response to determining a workload change associated with the new pending folding victim blockstripe (BS 3).

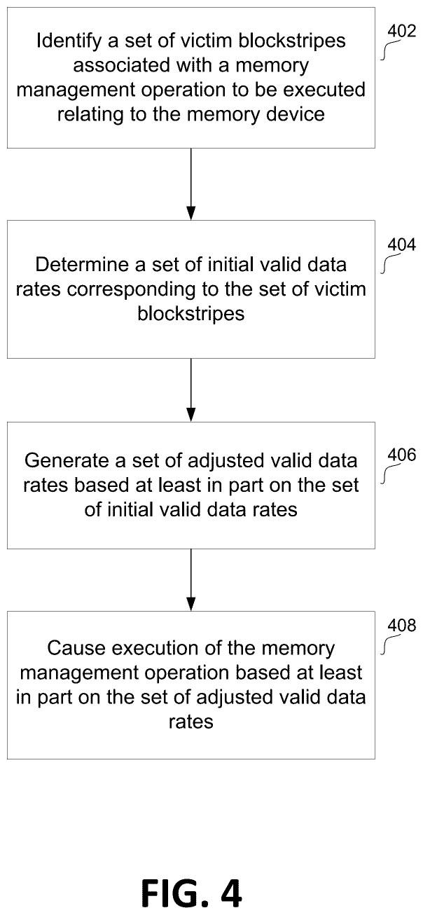

FIG. 4 is a flow diagram of an example method 400 to determine adjusted valid data rates (adjusted PVTC rates) associated with a set of victim blockstripes (i.e., folding victim blockstripes) corresponding to a media management operation (e.g., a folding operation) associated with a memory device of a memory sub-system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the rate control component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 402, the processing logic (e.g., rate control component 113 of FIG. 1) identifies a set of victim blockstripes (e.g., folding victim blockstripes) associated with a folding operation to be executed relating to a memory device (e.g., memory device(s) 130, 140 of FIG. 1). In an embodiment, the media management operation (e.g., folding operation) can include a garbage collection operation where data is moved from a current folding victim blockstripe to another blockstripe. According to embodiments, the folding operation includes one or more write operations (folding write operations) to write the data previously stored by the current folding victim blockstripe.

At operation 404, the processing logic determines a set of initial valid data rates corresponding to the set of victim blockstripes. According to embodiments, the initial valid data rate representing an amount of valid data (per blockstripe) that is to be moved or written to another blockstripe. In an embodiment, the initial valid data rate (PVTC rate) is determined as a ratio of a valid translation-unit (TU) count in a blockstripe to a total TU count in the blockstripe. In an embodiment, for each of the folding victim blockstripes, the processing logic determines a corresponding valid data rate. According to an embodiment, a first initial valid data rate is determined for a first folding victim blockstripe of the set of folding victim blockstripes, a second initial valid data rate is determined for a second folding victim blockstripe of the set of folding victim blockstripes, and so on.

At operation 406, the processing logic generates a set of adjusted valid data rates based at least in part on the set of initial valid data rates. According to embodiments, the set of folding victim blockstripes are sequenced or sorted by the initial valid data rate determined for each folding victim blockstripe. In an embodiment, the folding victim blockstripes are sorted from lowest relative initial valid data rate to a highest relative initial valid data rate. According to embodiments, an approximation associated with the initial valid data rates of the ordered or sorted sequence of folding victim blockstripes is generated. According to embodiments, the approximation (e.g., a least squares regression approximation) includes the set of adjusted valid data rates. In an embodiment, each folding victim blockstripe is divided into a number of sections, where each section is marked by a boundary corresponding to a blockstripe index value. According to embodiments, each adjusted valid data rate of the set of adjusted valid data rates is assigned to each section of the respective folding victim blockstripes.

At operation 408, the processing logic causes execution of the media management operation (e.g., folding operation) based at least in part on the set of adjusted valid data rates. According to embodiments, the folding operation is executed based on a host write rate that is determined based at least in part on the set of adjusted valid data rates. In an embodiment, the processing logic determines a folding write rate based on a current host usage level and a write allowance. In an embodiment, the processing logic determines a ratio that represents a required speed multiple of the folding write rate over a host write rate (i.e. a multiple at which the folding write rate is set over the host write rate if the memory device's free space is be maintained at a target constant level). The ratio is used to determine a reference host write rate. According to embodiments, the host write rate is calculated as a scaled up or scaled down value based on the reference host write rate, based at least in part on the current free space level.

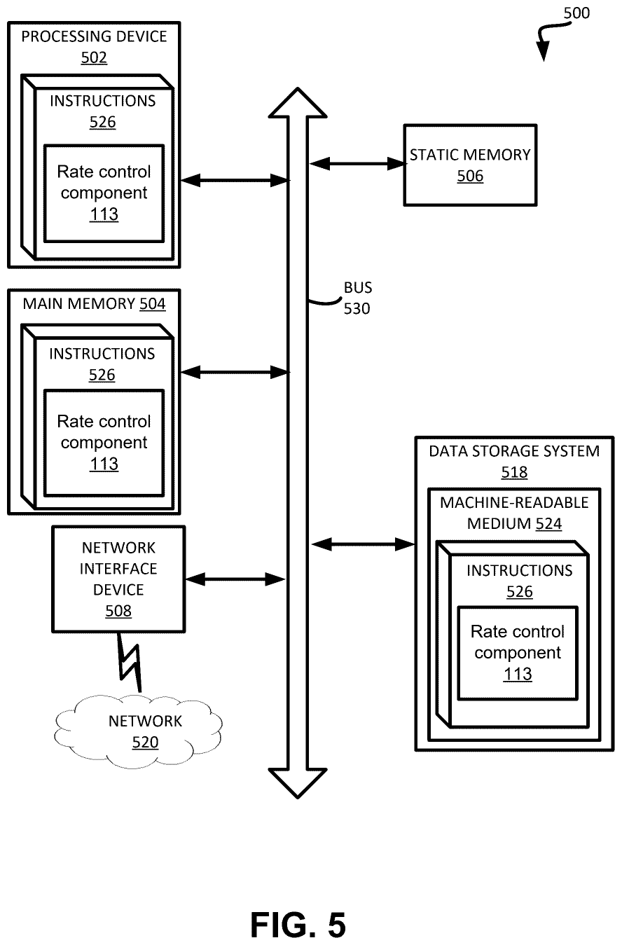

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the rate control component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a rate control component (e.g., the rate control component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
identifying a set of victim blockstripes associated with a media management operation to be executed relating to the memory device;
determining a set of initial valid data rates corresponding to the set of victim blockstripes; and
generating a set of adjusted valid data rates based at least in part on the set of initial valid data rates; and
causing execution of the media management operation based at least in part on the set of adjusted valid data rates.

2. The system of claim 1, further comprising:
generating an approximation based at least in part on the set of initial valid data rates, wherein the approximation comprises the set of adjusted valid data rates.

3. The system of claim 1, further comprising:
determining a sequence of the set of victim blockstripes based at least in part on an initial valid data rate corresponding to each of the victim blockstripes; and
identifying, based on the sequence, a current victim blockstripe of the set of victim blockstripes for use in the media management operation.

4. The system of claim 1, wherein the media management operation comprises a folding operation.

5. The system of claim 1, further comprising determining a host write rate based at least in part on the set of adjusted valid data rates.

6. The system of claim 5, further comprising executing a host write operation based at least in part on the host write rate.

7. The system of claim 1, further comprising segmenting each victim blockstripe of the set of victim blockstripes into a plurality of blockstripe sections, wherein an adjusted valid data rate of the set of adjusted valid data rates is assigned to each of the plurality of blockstripe sections.

8. A method comprising:
identifying, by a processing device, a set of victim blockstripes associated with a media management operation to be executed relating to a memory device;
determining a set of initial valid data rates corresponding to the set of victim blockstripes;
generating a set of adjusted valid data rates based at least in part on the set of initial valid data rates; and
causing execution of the media management operation based at least in part on the set of adjusted valid data rates.

9. The method of claim 8, further comprising generating an approximation based at least in part on the set of initial valid data rates, wherein the approximation comprises the set of adjusted valid data rates.

10. The method of claim 8, further comprising:
determining a sequence of the set of victim blockstripes based at least in part on an initial valid data rate corresponding to each of the victim blockstripes; and
identifying, based on the sequence, a current victim blockstripe of the set of victim blockstripes for use in the media management operation.

11. The method of claim 8, wherein the media management operation comprises a folding operation.

12. The method of claim 8, further comprising determining a host write rate based at least in part on the set of adjusted valid data rates.

13. The method of claim 12, further comprising executing a host write operation based at least in part on the host write rate.

14. The method of claim 8, further comprising segmenting each victim blockstripe of the set of victim blockstripes into a plurality of blockstripe sections, wherein an adjusted valid data rate of the set of adjusted valid data rates is assigned to each of the plurality of blockstripe sections.

15. A non-transitory computer-readable storage medium comprising instructions that, when executed by a processing device, cause the processing device to perform operations comprising:
identifying a set of victim blockstripes associated with a media management operation to be executed relating to a memory device;
determining a set of initial valid data rates corresponding to the set of victim blockstripes;
generating a set of adjusted valid data rates based at least in part on the set of initial valid data rates; and
causing execution of the media management operation based at least in part on the set of adjusted valid data rates.

16. The non-transitory computer-readable storage medium of claim 15, the operations further comprising generating an approximation based at least in part on the set of initial valid data rates, wherein the approximation comprises the set of adjusted valid data rates.

17. The non-transitory computer-readable storage medium of claim 15, the operations further comprising:
determining a sequence of the set of victim blockstripes based at least in part on an initial valid data rate corresponding to each of the victim blockstripes; and
identifying, based on the sequence, a current victim blockstripe of the set of victim blockstripes for use in the media management operation.

18. The non-transitory computer-readable storage medium of claim 15, wherein the media management operation comprises a folding operation.

19. The non-transitory computer-readable storage medium of claim 15, the operations further comprising:
determining a host write rate based at least in part on the set of adjusted valid data rates; and
executing a host write operation based at least in part on the host write rate.

20. The non-transitory computer-readable storage medium of claim 15, the operations further comprising segmenting each victim blockstripe of the set of victim blockstripes into a plurality of blockstripe sections, wherein an adjusted valid data rate of the set of adjusted valid data rates is assigned to each of the plurality of blockstripe sections.
